(19) United States
(12) Patent Application Publication
(10) Pub. No.: US 2004/0125946 A1
(43) Pub. Date: Jul. 1, 2004

(54) Programmable light source device for mobile phone display

(76) Inventor: Chih-Hung Sung, Su-Lin (TW)

Correspondence Address: Chih-Hung Sung, 1F No. 206 Bo-An Street, Section 1, Su-Lin City, Taipei Hsien, TW

(21) Appl. No.: 10/736,097

(22) Filed: Dec. 16, 2003

Related U.S. Application Data
(63) Continuation-in-part of application No. 09/604,269, filed on Jun. 26, 2000.

(51) Int. Cl. H04M 1/00; H04M 9/00

(52) U.S. Cl. 379/428.01; 455/575.1

(57) ABSTRACT

A programmable light source device for mobile phone displays is provided, including an electroluminance panel, and a driving integrated circuit (IC). The electroluminance provides luminance light source to the mobile phone display and is capable for light color change. The driving IC sends out signals to the electroluminance panel in order to control its activation and color change, including change timing and patterns. The driving IC also receives input from the user through the keypad to set the desired illumination effect and color change.

### CROSS-REFERENCE TO RELATED APPLICATION

The present invention is a continuation-in-part of U.S. patent application Ser. No. 09/604,269 filed on Jun. 26, 2000.

### FIELD OF THE INVENTION

The present invention relates to a light source device for mobile phone displays and, more particularly, to a programmable light source device employing electroluminance panels as the mobile phone display.

### BACKGROUND OF THE INVENTION

A mobile phone with a light source, such as a light emitting diode (LED), can be operated under insufficient light environment as the LED light source device provides illumination. However, the LED light source is a “dot” light source and the intensity or brightness of the “dot” light source decreases as the distance from the source increases. Therefore, the luminance of LED is not even. In addition, LED can only be positioned at the lateral side of a liquid crystal display (LCD) and therefore, the illumination effect of this conventional light source device is poor.

In order to improve the illumination effect, one of the conventional methods is to increase the number of the LEDs. For most mobile phones available in the market, four LEDs are arranged in a row and located beside the LCD. However, this method also increases the electrical energy consumption as well as the difficulty of mounting additional electrical elements. Furthermore, the problem of the unevenness of a “dot” light source still remains. It is imperative to find an alternative light source to meet the continuous progress in mobile phones.

### SUMMARY OF THE INVENTION

Accordingly, it is an object of the present invention to provide a programmable light source device for mobile phone display, comprising an electroluminance panel and a driving integrated circuit (IC) mounted within a housing of the mobile phone. The driving IC is programmable in that it can receive instructions from the user, and based on the instruction to set the color change pattern.

Another object of the present invention is to provide a programmable light source device for mobile phone display, wherein the electrical energy consumption is lower than that of the LED.

Yet a further object of the present invention is to provide a programmable light source device for mobile phone display, wherein the illumination effect is better than that of a light source employing an LED.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows a perspective exploded view of the present invention.

FIG. 2 shows a circuit diagram of the electroluminance panel and the driving IC in accordance with the present invention.

FIG. 3 shows a structural diagram of the electroluminance panel in accordance with the present invention.

### DETAILED DESCRIPTION OF PREFERRED EMBODIMENT

For the purpose of promoting an understanding of the principles of the invention, references will be made to the embodiment illustrated in the drawings. Specific languages are used in description. It should, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

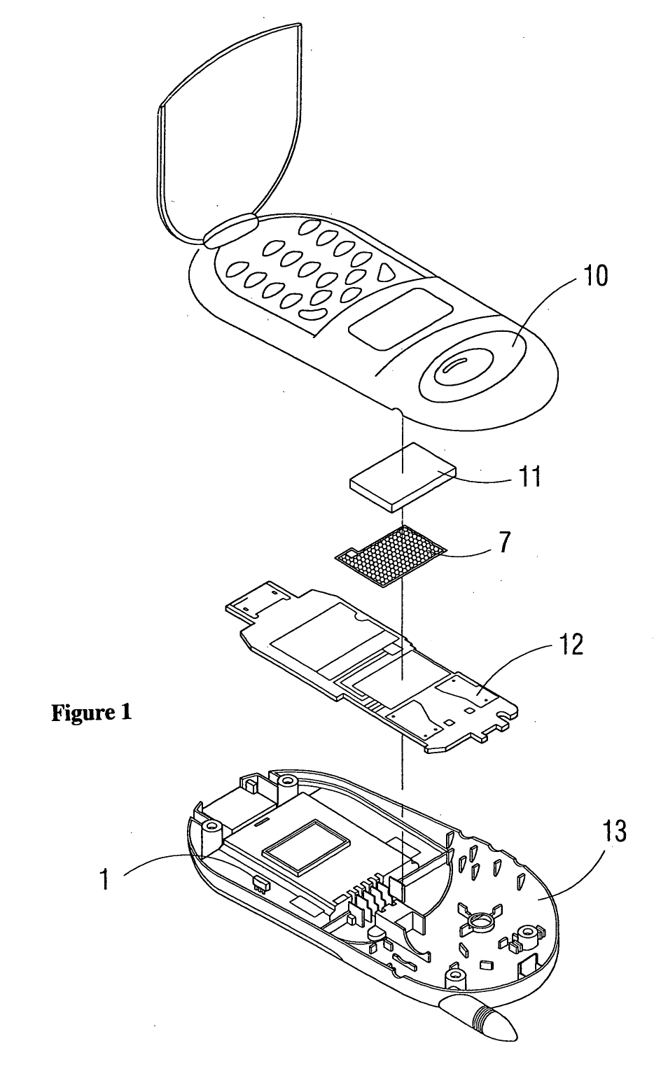

FIG. 1 shows a perspective exploded view of the present invention. In accordance with the present invention, a phone panel 12 of a mobile phone is appropriately located on a lower housing body 13 of the mobile phone. An LCD display 11 is located above an electroluminance panel 7, closely combined together with a lower housing body 13 of the mobile phone.

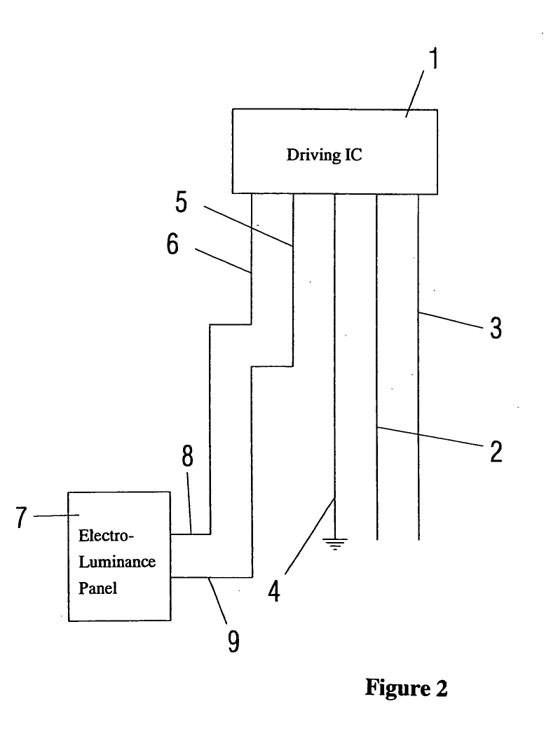

FIG. 2 shows a schematic view of the driving circuit and the electroluminance panel of the present invention. In accordance with the present invention, a driving IC 1 is provided with five or four connection pins. The driving IC 1 includes a circuit for regulating the voltage and a circuit for time pulse control. A first connection pin 6 and a second connection pin 5 of the driving IC 1 are connected to a first control connection pin 8 and a second connection pin 9 of the electroluminance panel 7, respectively. Connection pins 2 and 3 of the driving IC 1 are connected to positive and negative terminals of a power source, respectively. A ground wire 4 is also provided. A voltage Vcc that drives the electroluminance panel 7 is provided by a phone plate 12 of the mobile phone. Through the voltage regulating circuit of the driving IC 1, the frequency can be changed and the electroluminance panel 7 is able to emit light of different wavelengths, namely, exhibition of color changes. In addition, the time pulse control circuit of the driving IC 1 is used to control the timing of color change of the electroluminance panel 7, for example, every two seconds.

In accordance with the present invention, when the mobile phone is turned ON, or a keypad is pressed, a control circuit of phone plate 12 provides a control signal to the driving IC 1. Furthermore, the keypad can also serve as an input device for the user to select and set the desired operation effect of the electroluminance panel 7. Hence, the timing and patterns of color change of the electroluminance panel 7 is programmable.

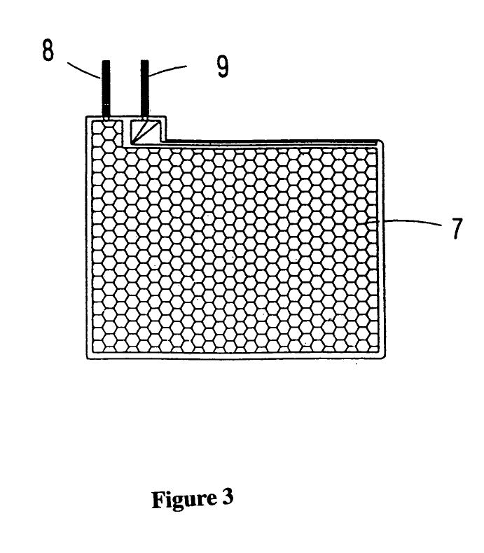

As shown in FIG. 3, the connection pins 8, 9 of the electroluminance panel 7 are connected respectively to the connection pins 6, 5 of the driving IC 1 for transmitting driving signals of high and low voltage levels. As the electroluminance panel needs a high/low voltage to drive, the driving IC 1 is provided in the present invention to drive the electroluminance panel 7 and to cause color change.

Experiments show that the electrical energy consumption of the electroluminance panel is much less that of an LED. Also, the light emitted from the electroluminance panel is a surface light source, which provides better illumination effect than a dot light source, such as the LED. In addition, as the light source of the electroluminance panel is located beneath the LCD, the illumination effect is better than the LED light source located at the side of the LCD.

While the invention has been described in connection with what is presently considered to the most practical and preferred embodiment, it is to be understood that the invention is not to be limited to the disclosed embodiment, but, on the contrary, it should be clear to those skilled in the art that the description of the embodiment is intended to cover various modifications and equivalent arrangement included within the spirit and scope of the appended claims.

What is claimed is:

1. A programmable light source device for mobile phone displays, comprising:
an electroluminance panel providing a luminance light source to the mobile phone displays; and
a driving integrated circuit mounted within a housing of a mobile phone for sending out signals to control the electroluminance panel on illumination effects, and to receive input from a keypad on the mobile phone to set desired illumination effects.

2. The programmable light source device as claimed in claim 1, wherein the illumination effects of the electroluminance panel comprise luminance intensity, luminance color, color change timing and patterns.
